(19) United States
(12) Patent Application Publication
(10) Pub. No.: US 2011/0141321 A1
(43) Pub. Date: Jun. 16, 2011

(54) METHOD AND APPARATUS FOR TRANSFORMING A LENS-DISTORTED IMAGE TO A PERSPECTIVE IMAGE IN BAYER SPACE

(75) Inventors: Bei Tang, Palatine, IL (US); James E. Crenshaw, Palatine, IL (US)

(73) Assignee: GENERAL INSTRUMENT CORPORATION, Horsham, PA (US)

(21) Appl. No.: 12/639,376

(22) Filed: Dec. 16, 2009

(51) Int. Cl. H04N 5/217

(52) U.S. Cl. 348/240.99; 348/241; 348/273; 348/333.12; 348/335; 348/E05.078

(57) ABSTRACT

A method and apparatus is provided for rendering an image. The method includes capturing a distorted input image using a color filter array to obtain an input image pattern having a single color channel per pixel. The input image is transformed to an input image signal. At least a portion of the input image signal is dewarped to obtain an undistorted image signal by (i) identifying selected coordinate points in the input signal that correspond to coordinate points in the undistorted image signal and (ii) determining a first color channel value for at least one of the selected coordinate points with a color correlation-adjusted interpolation technique using at least one nearest neighbor pixel having a color channel different from the first color channel.

### FIELD OF THE INVENTION

The present invention relates to a method and apparatus for transforming a distorted wide angle field-of-view image into a non-distorted, normal perspective image at any orientation, rotation, and magnification within the field-of-view, which is electronically equivalent to a mechanical pan, tilt, zoom, and rotation camera viewing system.

### BACKGROUND OF THE INVENTION

Camera viewing systems are utilized for a large variety of different purposes, including surveillance, inspection, security and remote sensing as well as mainstream applications such as consumer digital imaging and real time video conferencing. The majority of these systems use either a fixed-mount camera with a limited viewing field, or they utilize mechanical pan-and-tilt platforms and mechanized zoom lenses to orient the camera and magnify its image. While a mechanical solution may often be satisfactory when multiple camera orientations and different degrees of image magnification are required, the mechanical platform can be cumbersome, relatively unreliable because of the many moving parts it requires, and it can occupy a significant volume, making such a viewing system difficult to conceal or use in close quarters. As a result, several stationary cameras are often used to provide wide-angle viewing of a workspace.

More recently, camera viewing systems have been developed that perform the electronic equivalent of mechanical pan, tilt, zoom, and rotation functions without the need for moving mechanisms. One method of capturing a video image that can be electronically processed in this manner uses a wide-angle lens such as a fisheye lens. Fisheye lenses permit a large sector of the surrounding space to be imaged all at one time, but they produce a non-linear distorted image as a result. While ordinary rectilinear lenses map incoming light rays to a planar photosensitive surface, fisheye lenses map them to a spherical surface, which is capable of a much wider field of view. In fact, fisheye lenses may even encompass a field of view of 180°. By capturing a larger section of the surrounding space, a fisheye lens camera affords a wider horizontal and vertical viewing angle, provided that the distorted images on the spherical surface can be corrected and transformed in real time.

The process of transforming distorted images to accurate perspective images is referred to as “dewarping.” Dewarping the image restores the captured scene to proper perspective based upon the orientation of the perspective view. A (Digital Pan Tilt Zoom) DPTZ processor is generally employed to perform the dewarping process. Unfortunately, dewarping can be a computationally intensive process that requires significant processing resources, including a processor having a high data bandwidth and access to a large amount of memory.

### SUMMARY

In accordance with one aspect of the invention, a method is provided for rendering an image. The method includes capturing a distorted input image using a color filter array to obtain an input image pattern having a single color channel per pixel. the input image is transformed to an input image signal. At least a portion of the input image signal is dewarped to obtain an undistorted image signal by (i) identifying selected coordinate points in the input signal that correspond to coordinate points in the undistorted image signal and (ii) determining a first color channel value for at least one of the selected coordinate points with a color correlation-adjusted interpolation technique using at least one nearest neighbor pixel having a color channel different from the first color channel.

In accordance with another aspect of the invention, an imaging system provides an undistorted view of a selected portion of a lens-distorted optical image. The imaging system includes a lens for obtaining a lens-distorted input optical image and a digital image capture unit for capturing the input optical image to obtain an input image pattern having a single color channel per pixel. The imaging system also includes a processor transforming a selected portion of the input image pattern to produce an undistorted output image. The processor is configured to perform the transformation by dewarping the input image pattern in Bayer space using color correlation-adjusted linear interpolation.

### BRIEF DESCRIPTION OF THE DRAWINGS

FIG. 1 shows a schematic diagram of a camera viewing system employing a wide angle lens.

FIG. 2 shows one example of a Bayer filter.

FIG. 3 illustrates the transformation between a desired output image and a captured input image that is projected onto an image sensor plane.

FIG. 4 illustrates the dewarping process when it is performed on an color image pattern that has already undergone a demosaicing process so that each pixel includes three color channels.

FIG. 5 illustrates the dewarping process when it is performed on a Bayer image pattern.

FIG. 6 illustrates a dewarping process that is performed in Bayer space using a color correlation-adjusted interpolation technique.

FIG. 7 is a flowchart illustrating one example of a method for rendering an undistorted optical image from a lens-distorted optical image.

### DETAILED DESCRIPTION

As detailed below, a wide-angle camera viewing system is provided that produces the equivalent of pan, tilt, and zoom functions by efficiently performing real-time distortion correction processes that can be implemented on an embedded processor, ASIC or FPGA.

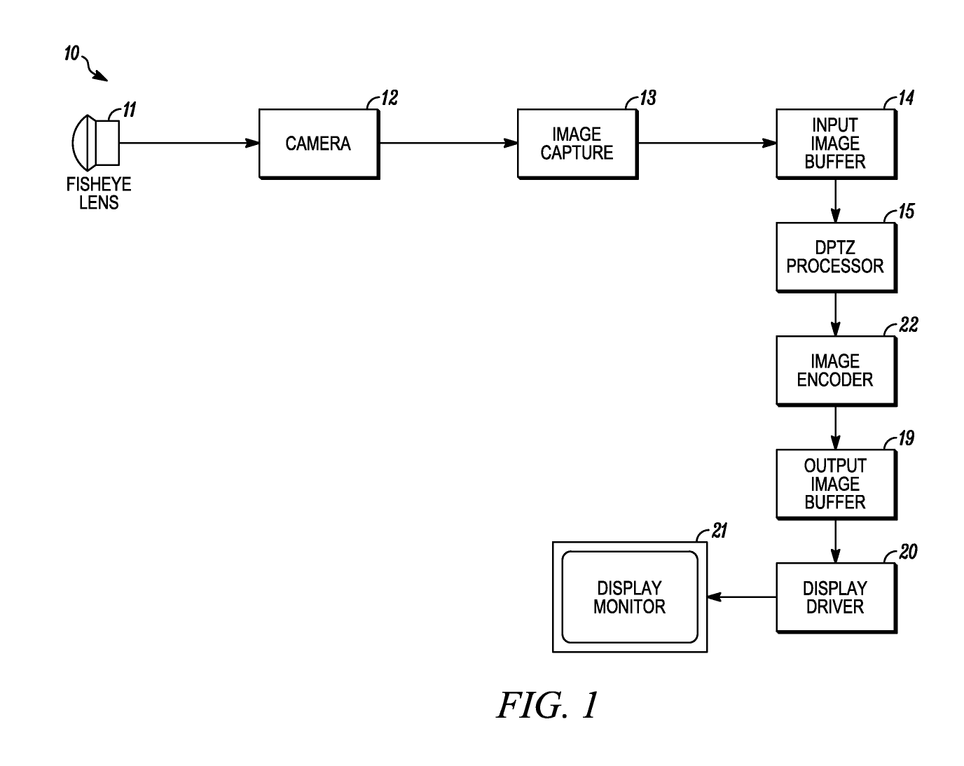

The principles of image transform described herein can be understood by reference to the illustrative camera viewing system 10 of FIG. 1. Shown schematically at 11 is a wide angle, e.g., a fisheye, lens that provides an image of the environment with a wide angle field of view, e.g., a 180 degree field-of-view. More generally, the lens 11 may produce other types of distorted images instead of a wide-angle image. The lens is attached to a camera 12 that converts the optical image into an electrical signal. If not already in a digital format, these signals are then digitized electronically by a digital image capture unit 13 and stored in an image buffer 14. A (Digital Pan Tilt Zoom) DPTZ processor 15 selects a portion of the input image captured by the wide angle lens 11 and then transforms that portion of the image to provide a perspective image with the proper perspective view. The portion of the input image that is selected will generally be selected by a user via a user interface (not shown) that is incorporated into the camera viewing system. The portion of the input image selected by the user generally corresponds to a pan, tilt, zoom and/or rotation process that is to be performed on the input image. The resulting perspective image is then sent to an image encoder 22, which performs a demosaicing process. The image encoder 22 may also compress the image. The demosaiced output image is stored in an output image buffer 19. The output image buffer 19 is scanned out by a display driver 20 to a video display device 21 on which the output image may be viewed. In alternate examples, any or all of the aforementioned components of the camera system may be remotely located from one another, in which case data can be transferred among the components over a network.

Camera 12 includes a photosensor pixel array such as a CCD or CMOS array, for example. A color filter array (CFA), or color filter mosaic (CFM) is arranged over the pixel array to capture color information. Such color filters are needed because the typical photosensors detect light intensity with little or no wavelength_specificity, and therefore cannot separate color information.

One example of a CFA is a Bayer filter, which gives information about the intensity of light in red, green, and blue (RGB) wavelength regions. When a Bayer pattern is used, filtering is provided such that every other pixel collects green light information (“green pixels”) and the pixels of alternating rows of the sensor collect red light information (“red pixels”) and blue light information (“blue pixels”), respectively, in an alternating fashion with pixels that collect green light information.

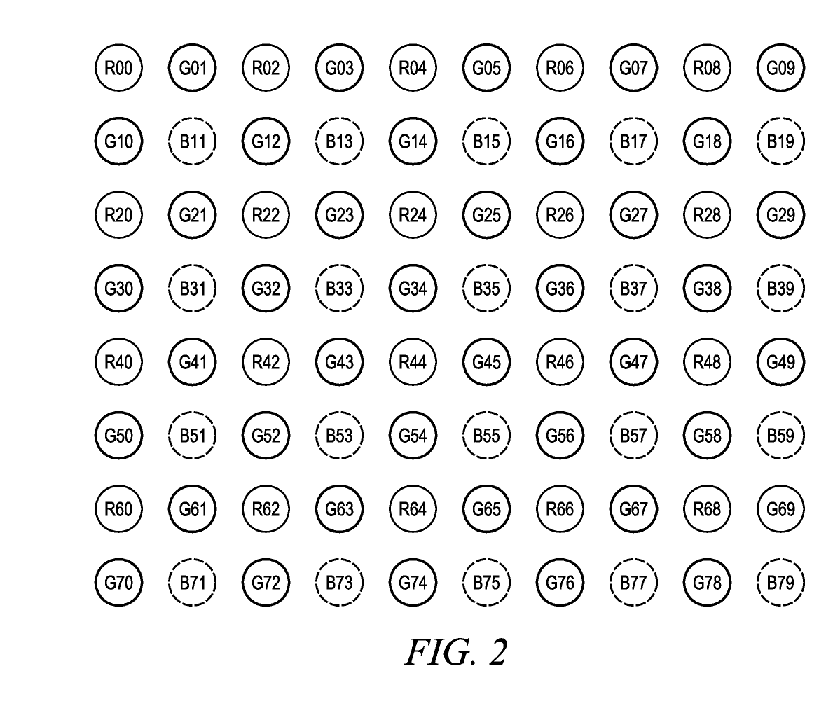

FIG. 2 shows one example of a Bayer filter. In the figure the character R represents a red pixel, G represents a green pixel and B represents a blue pixel. As to numerical subscripts with the respective characters P, R, G and B, the first digit denotes the row number of a pixel in a matrix region, and the second digit denotes the column number of a pixel in the matrix region. The characters R, G and B may each indicate a pixel value as well as a numerical expression. For instance, the character P₁₁ indicates a pixel itself located in the first column and first row as well as a pixel value of the pixel located in the first column and first row. The raw output of a Bayer-filter camera is referred to as a Bayer image pattern that is represented in Bayer space. Since each pixel is filtered to record only one of the three colors, two-thirds of the color data is missing from each pixel.

It should be noted that instead of a Bayer filter, other types of color filter arrays may be employed. Illustrative examples of such filters include an RGBE filter, a CYYM filter, a CYGM filter, an RGBW filter and the like. For purposes of illustration, however, the following discussion will primarily be presented in terms of a Bayer filter.

As noted above, due to the sampling by the color filter array, there is missing color values in each pixel of an image represented in Bayer space. The process to restore the color values is called demosaicing. Demosaicing algorithms estimate missing color information by interpolation of the known color information across different color planes. Many different algorithms exist. Such demosaicing algorithms estimate the missing color information for each given pixel position by evaluating the color information collected by adjacent pixels.

As noted above, the DPTZ processor 15 shown in FIG. 1 transforms input images captured with the fisheye lens to output images that represent a perspective view. The perspective view represents how a traditional camera would have captured the image at a particular pan, tilt, and zoom setting. The processor 15 can be implemented on a single-chip, multiple chips or multiple electrical components. For example, various architectures can be used for the processor 15, including a dedicated or embedded processor, a single purpose processor, controller, application specific integrated circuit (ASIC), field-programmable gate array (FPGA) and so forth.

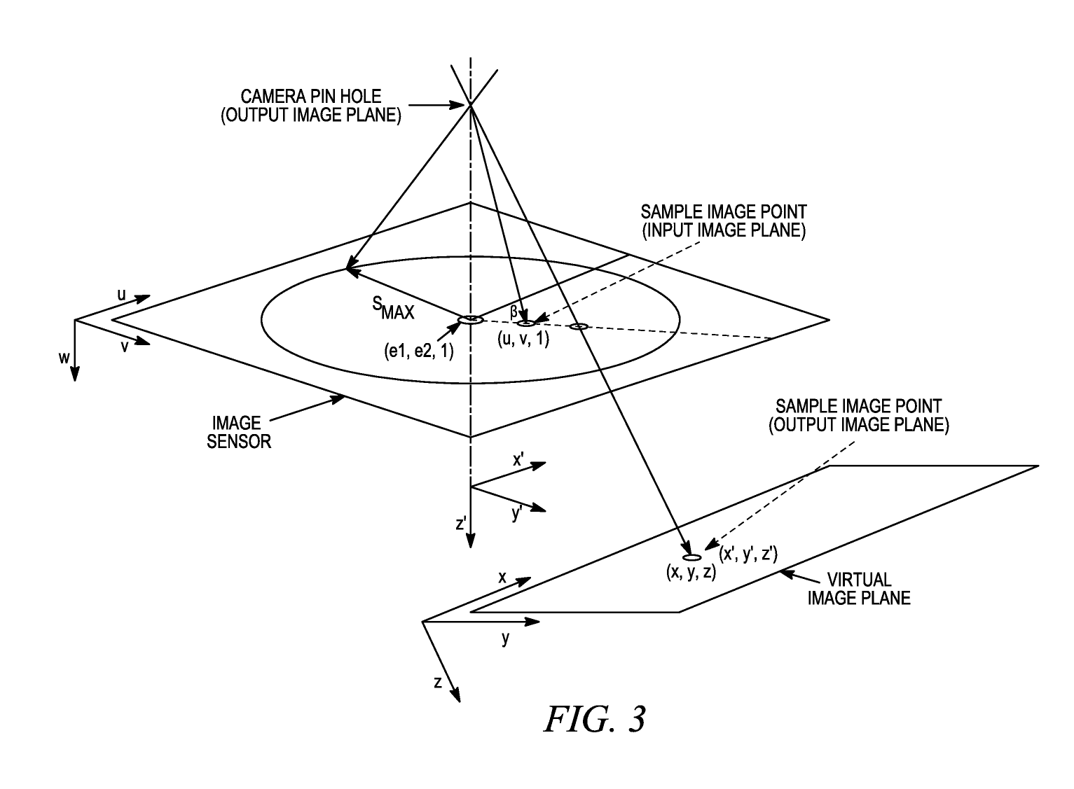

The transform between the desired output image and the captured input image can be modeled by first considering a standard pinhole camera. As illustrated in FIG. 3, light enters a pin hole and is imaged onto an image sensor plane. In a conventional camera that has mechanical pan, tilt and zoom capabilities, the sensor would be located on the image sensor plane. It would be mechanically panned and tilted to capture images at different viewing angles. The lens (or sensor) would be moved along the axis normal to the image sensor plane to zoom in or out.

The DPTZ processor 15 is used to construct the output image on the virtual image plane from the input image that is received on the image sensor plane. To do this, the virtual image plane is segmented into sample points. The sample points are mapped back onto the image sensor plane. The process of mapping (x,y) sample points in the virtual image plane back onto the image sensor (u,v) coordinates is called “inverse mapping.” That is, the inverse mapping process maps the (x,y) output image coordinates in the virtual image plane onto the (u,v) input image coordinates in the image sensor plan. Various algorithms are well known to perform the inverse mapping process.

Conventional dewarping or inverse mapping processes are generally performed in full color space. That is, the inverse mapping is performed after demosaicing has been performed to reconstruct an image that includes three color channels for each pixel. One problem that arises when dewarping or inverse mapping is performed on a demosaiced image is that the DPTZ processor 15 needs to process all three color channels, which requires the processor to have a high data bandwidth and large memory storage.

In order to reduce the computational burdens that are placed on the DPTZ processor 15 the camera viewing system 10 of FIG. 1 performs the dewarping mapping process on the image represented in Bayer space instead of the color image obtained after demosaicing. In this way the DPTZ processor 15 only needs to deal with one color channel for each pixel, thereby saving data bandwidth and memory storage. Demosaicing may then be performed on the perspective output image by image encoder 22. Unfortunately the color image that results when conventional dewarping is performed in Bayer space is lower in quality in comparison to a color image that is obtained when the same conventional dewarping is performed in full color space. In particular, visible artifacts are produced such as image blur, zippers on object boundaries and as well as other edge artifacts.

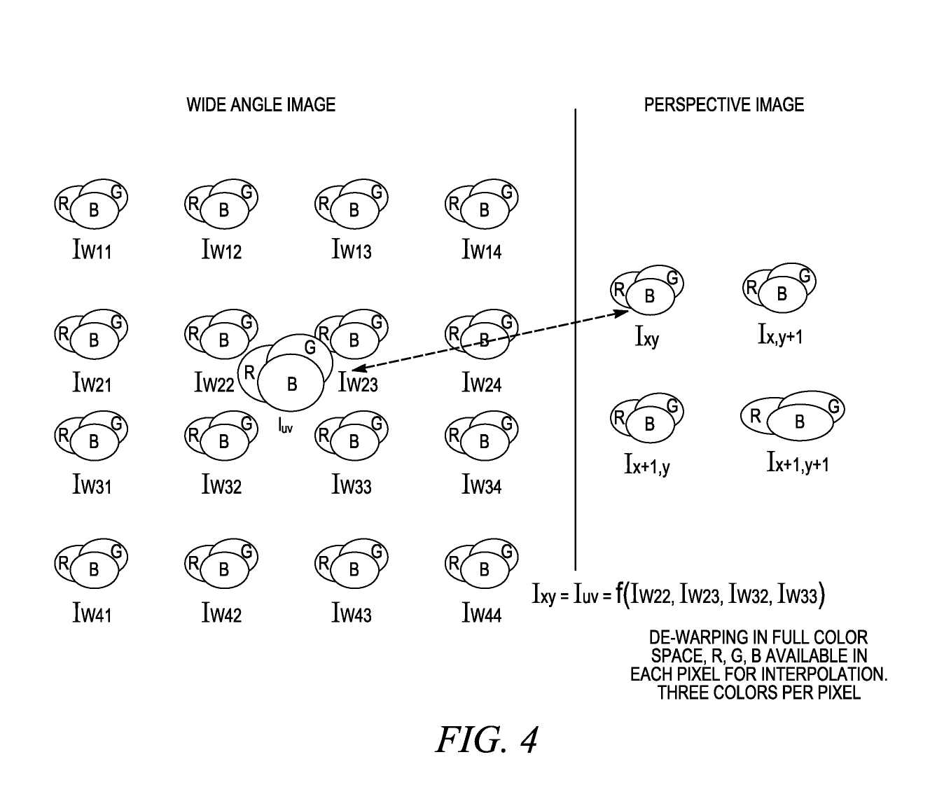

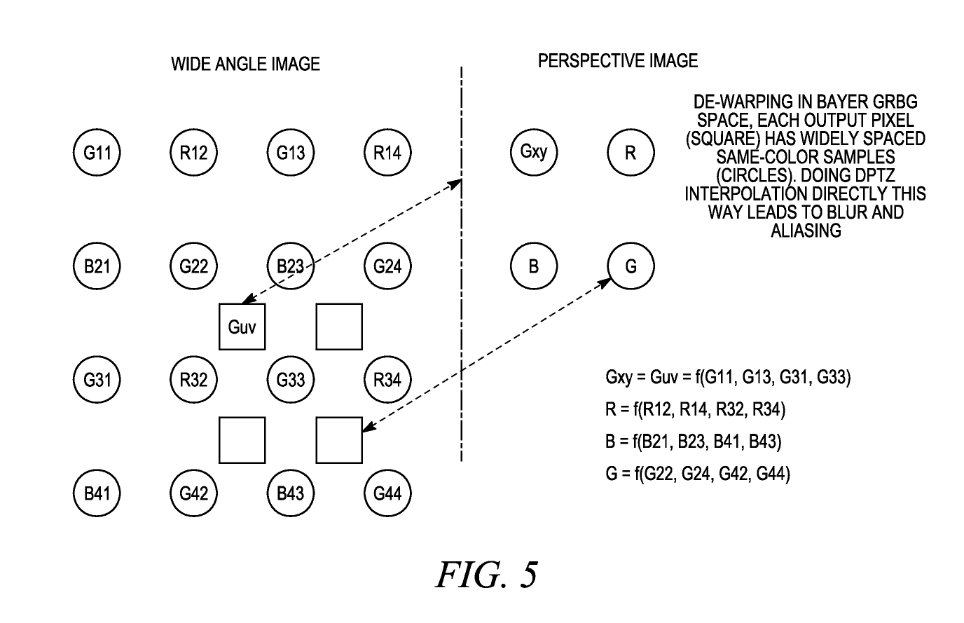

This reduction in image quality can be explained with reference to FIGS. 4 and 5. FIG. 4 illustrates the dewarping process when it is performed on a color image pattern that has already undergone a demosaicing process so that each pixel includes three color channels. The left portion of the figures shows the pixels Iw in the wide angle image and the right portion shows selected pixels in the corresponding perspective image. As shown the perspective image pixel Ixy is mapped to a virtual pixel Iuv at the center of the square defined by pixels Iw22, Iw23, Iw32 and Iw33 in the wide angle image. The value of the pixel Ixy can thus be obtained by interpolation as follows:

Ixy=Iuv=f(Iw22, Iw23, Iw32, Iw33) (1)

As previously mentioned, this dewarping process illustrated in FIG. 3 can result in good image quality, but requires substantial processing resources.

FIG. 5 illustrates the dewarping process when it is performed on a Bayer image pattern (i.e., an image pattern represented in Bayer space before undergoing demosaicing). As the figure indicates, in this case each pixel only includes a single color channel. As shown the perspective image green pixel Gxy is mapped to virtual green pixel Guy. In order to perform interpolation to determine the value Guy, actual existing green pixels surrounding Guy are selected. In this case Guy is located at the center of the square sampling area defined by the actual green pixels G11, G13, G31 and G33 in the wide angle image. The value of the pixel Gxy can thus be obtained by interpolation as follows:

Gxy=Guy=f(G11, G13, G31, G33) (2)

Similar equations can be written for other pixels in perspective image, such as shown in FIG. 5 for pixels R, B and G.

Clearly, adjacent pixels of the same color channel are more widely spaced from one another in FIG. 5 than in FIG. 4, where each pixel contains each color channel. As a consequence the interpolation performed during the dewarping process of FIG. 5 employs a larger sampling area than the interpolation process performed during the dewarping process of FIG. 4. Thus, the resulting color image that is obtained from the dewarping process of FIG. 5 (before demosaicing) will be lower in quality than the resulting color image obtained from the dewarping process of FIG. 4.

Thus, in summary, dewarping an image pattern in Bayer space is computationally less complex than dewarping a full color image pattern, but at the expense of image quality.

As detailed below, the advantages of dewarping a Bayer image pattern can be maintained while achieving a higher image quality by using inter-color correlations between all adjacent pixels (even those pixels that differ in color) when performing interpolation during the dewarping process. In other words, within a small neighborhood on an image, it can be assumed that there is a correlation between the different color channels. For instance, in one color model the ratio between luminance and chrominance at the same position is assumed to be constant within the neighborhood.

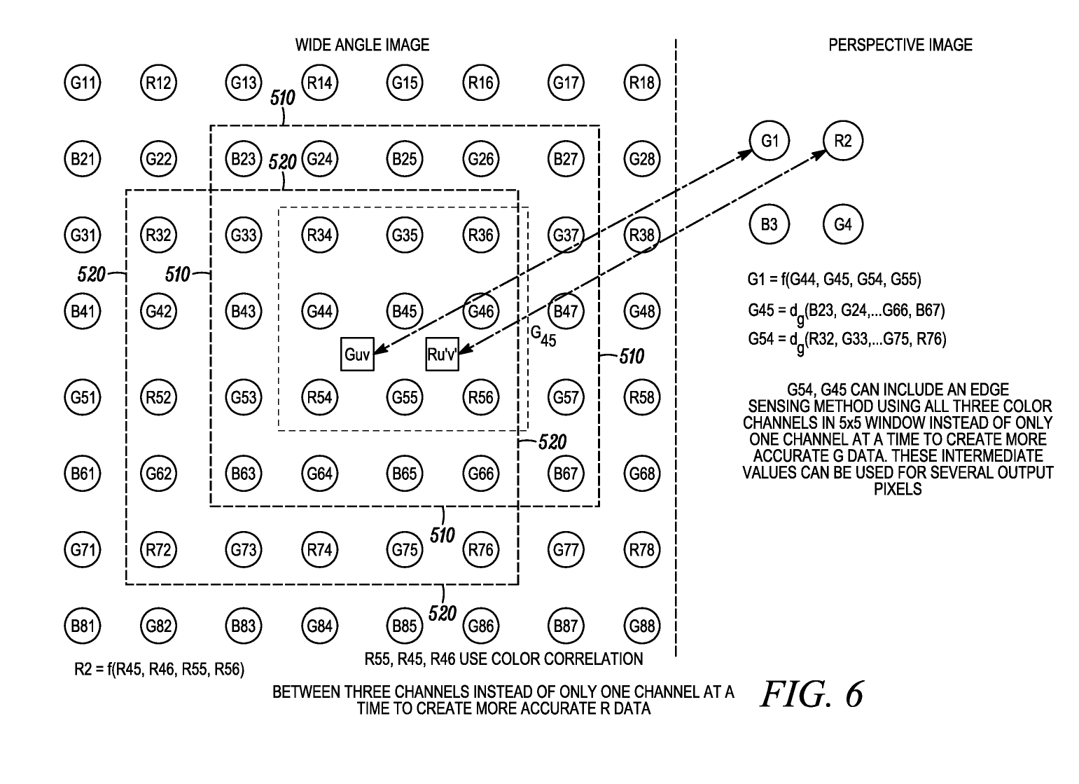

FIG. 6 illustrates a dewarping process that is performed in Bayer space using color information obtained from all nearest neighbors. A wide angle image of a Bayer image pattern is shown in the left portion of FIG. 6 and a perspective image pattern showing pixels G1, R2, B3 and G4 is shown on the right. As shown the perspective image pixel G1 is once again mapped to Guy. In order to perform interpolation to determine the value G1 in more accurate way, other closer by pixels surrounding Guy should be selected. In this case, however, Guy is located at the center of the square sampling area defined by pixels G44, B45, R54 and G55 in the wide angle image. Assume the green channel value for all the surrounding pixel is G44, G45, G54 and G55, the value of the pixel G1 can thus be obtained by interpolation as follows:

G1=Guv=f(G44, G45, G54, G55) (3)

In contrast to equation 2, not all the values of G44, G45, G54 and G55 are known. Specifically, G45 and G54 are unknown. Rather, only the values B45 and R54 are known. That is, for these two pixels the only color channel information available is different from the color channel information that is needed. Accordingly, it is necessary to estimate the values of G45 and G54. This can be accomplished in a number of different ways, one of which will be presented herein. The illustrated technique examines a window in the neighborhood of each pixel G45 and G54. For example, in FIG. 6 a window having a width and length of 5 pixels each is used. In particular, G45 is estimated from the pixels within the window represented by the rectangle formed from dashed lines 510. Likewise, G54 is estimated from the pixels within the window represented by the rectangle formed from dashed lines 520. Of course, windows having other dimensions may be used as well in order to obtain a satisfactory balance between computational complexity and image quality for any given application.

The estimation of G45 and G54 within their respective windows, which are needed to interpolate perspective image points (e.g., G1 in FIG. 6) when dewarping an image pattern obtained using a color filter array such as a Bayer filter, can be determined using any of a number of different color correlation-adjusted linear interpolation techniques. One example of such a technique that will be presented herein by way of illustration is referred to as an edge sensing algorithm.

An example of the edge sensing algorithm is illustrated in FIG. 6, in which the value of the green component of pixel B45 is to be determined from its nearest-neighbors in window 510. The value of the G component of pixel B45, denoted G45, may be determined as follows:

$$G 45 = \{ \begin{matrix}( G 35 + G 55 ) / 2 & if \begin{matrix}\vert ( B 25 + B 65 ) / 2 - B 45 \vert < \\ \vert ( B 43 + B 47 ) / 2 - B 45 \vert\end{matrix} \\ ( G 44 + G 46 ) / 2 & if \begin{matrix}\vert ( B 43 + B 47 ) / 2 - B 45 \vert < \\ \vert ( B 25 + B 65 ) / 2 - B 45 \vert\end{matrix} \\ ( G 35 + G 55 + G 44 + G 46 ) / 4 & otherwise\end{matrix} \qquad ( 4 )$$

In other words, if the difference between B25 and B65 is smaller than the difference between B43 and B47, then the inter-color correlation is assumed to be stronger in the vertical direction than in the horizontal direction. As a consequence G45 is calculated to be the average of the vertical nearest neighbors G35 and G55. On the other hand, if the difference between B43 and B47 is smaller than the difference between B25 and B55 then the inter-color correlation is assumed to be stronger in the horizontal direction, in which case G45 is calculated to be the average of the horizontal neighbors G44 and G46. Thus, the pixels used to estimate G45 are selected based on the inter-color correlation strength of its nearest neighbors in different directions. The selected pixels are those that are distributed in the direction with the greater or stronger inter-color correlation. In window 520 of FIG. 6, a similar result may be obtained for the value of the green component of pixel R54 as follows:

$$G 54 = \{ \begin{matrix}( G 44 + G 64 ) / 2 & if \begin{matrix}\vert ( R 34 + R 74 ) / 2 - R 54 \vert < \\ \vert ( R 52 + R 56 ) / 2 - R 54 \vert\end{matrix} \\ ( G 53 + G 55 ) / 2 & if \begin{matrix}\vert ( R 52 + R 56 ) / 2 - R 54 \vert < \\ \vert ( R 34 + R 74 ) / 2 - R 54 \vert\end{matrix} \\ ( G 53 + G 55 + G 44 + G 64 ) / 4 & otherwise\end{matrix} \qquad ( 5 )$$

Returning to FIG. 6, the edge sensing algorithm illustrated above in connection with FIG. 6 may be used to estimate the values of G45 and G54. Once these values have been determined, the value of G1 in the perspective image may be determined in accordance with equation 3 now that values for G44, G45, G54 and G55 are all available.

Once the green values of the pixels in the designated window (e.g., window 510) are known, other pixel values in the perspective image may be determined from the wide angle image in a similar manner. For instance, as shown in FIG. 6 the perspective image pixel R2 is mapped to the virtual wide angle image pixel Ru‘v’. Once again, Ru‘v’ may be interpolated from its nearest neighbors as follows:

R2=f(R45, R46, R55, R56) (6)

Since the values of R45, R46 and R55 are unknown, they may be estimated using a color correlation-adjusted linear interpolation technique such as the edge sensing algorithm to calculate the missing red channel from the blue channel and the missing red channel from the green channel. An illustrative calculation for the value of the red component of pixels B45, G46 and G55 is illustrated below based on a popular color correlation model within a local window, assuming that the difference between channels are assumed to be constant within the window:

R45=G45−½*((G34−R34)+(G36−R36)+(G54−R54)+(G56−R56))

R46=G46−½*((G36−R36)+(G56−R56))

R55=G55−½*((G54−R54)+(G56−R56)) (7)

Once again the edge sensing algorithm for red values illustrated above in connection with FIG. 6 may be used to estimate the values of R45, R46, R55. Once these values have been determined, the value of R2 in the perspective image may be determined in accordance with the above equation now that the values for R45, R46, R55, R56 are all available.

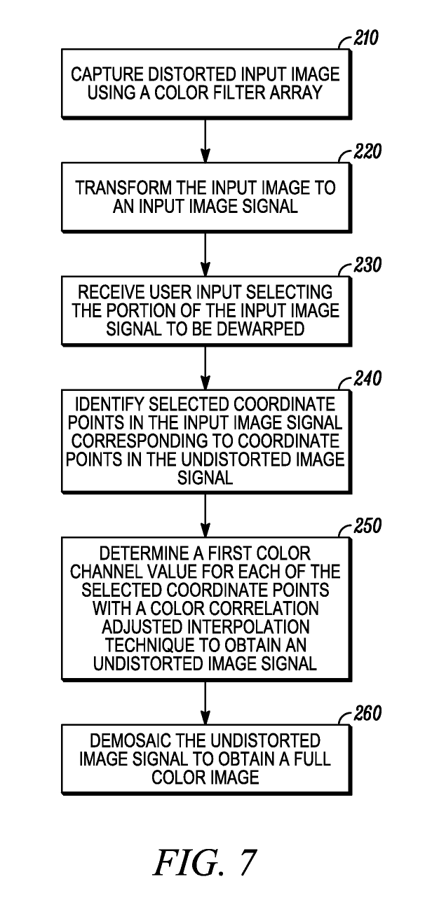

FIG. 7 is a flowchart illustrating one example of a method for rendering an image. The image begins in step 210 when an imaging system captures a distorted input image using a color filter array to obtain an input image pattern having a single color channel per pixel. The distorted input image may be, for example, a wide-angle image obtained with a wide-angle lens such as a fisheye lens. The input image is transformed to an input image signal in step 220. Next, in step 230, the user interface associated with the imaging system receives user input selecting the portion of the input image signal that is to be dewarped in accordance with a pan, tilt, and/or zoom operation. A portion of the input image signal is next dewarped in accordance with the user input to obtain an undistorted image signal. The dewarping process begins in step 240 by identifying selected coordinate points in the input signal that correspond to coordinate points in the undistorted image signal. A first color channel value is determined in step 250 for at least one of the selected coordinate points with a color correlation-adjusted interpolation technique using at least one nearest neighbor pixel having a color channel different from the first color channel. In some cases the color-correlation adjusted interpolation technique uses a plurality of neighboring pixels that are located within a window of predetermined size. After completing the dewarping process of steps 240 and 250 for all the coordinate points in the portion of the input image signal that is to be dewarped, the resulting undistorted image signal undergoes demosaicing in step 260 to obtain a full color image.

The processes described above, including but not limited to those presented in connection with FIG. 7, may be implemented in general, multi-purpose or single purpose processors. Such a processor will execute instructions, either at the assembly, compiled or machine-level, to perform that process. Those instructions can be written by one of ordinary skill in the art following the description presented above and stored or transmitted on a computer readable medium. The instructions may also be created using source code or any other known computer-aided design tool. A computer readable medium may be any storage medium capable of carrying those instructions and include a CD-ROM, DVD, magnetic or other optical disc, tape or silicon memory (e.g., removable, non-removable, volatile or non-volatile).

An imaging system has been described that can efficiently produce the equivalent of pan, tilt, and zoom functions by performing real-time distortion correction on a lens-distorted image. This result is achieved by leveraging, during the dewarping process, color-correlations that exist among neighboring pixels. Among its other advantages, some of which have been noted above, the imaging system can avoid the need for a separate image signal processor that is often otherwise needed to perform the demosaicing process prior to the dewarping process. The extra processor can be eliminated because commercially available encoders that are typically used to compress the image after dewarping may in some cases also be used in the present arrangement to perform the demosaicing process.

1. A method for rendering an image, comprising:
capturing a distorted input image using a color filter array to obtain an input image pattern having a single color channel per pixel;
transforming the input image to an input image signal;
dewarping at least a portion of the input image signal to obtain an undistorted image signal by (i) identifying selected coordinate points in the input signal that correspond to coordinate points in the undistorted image signal and (ii) determining a first color channel value for at least one of the selected coordinate points with a color correlation-adjusted interpolation technique using at least one nearest neighbor pixel having a color channel different from the first color channel.

2. The method of claim 1 wherein the color-correlation adjusted interpolation technique uses a plurality of neighboring pixels that are located within a window of predetermined size, said window encompassing the at least one selected coordinate point.

3. The method of claim 2 wherein the color correlation-adjusted linear interpolation technique is an edge sensing linear interpolation technique.

4. The method of claim 1 wherein the color filter array is a Bayer filter and the input image pattern is a Bayer image pattern.

5. The method of claim 1 wherein the distorted input image is a wide-angle image.

6. The method of claim 1 further comprising receiving user input selecting the portion of the input image signal to be dewarped.

7. The method of claim 6 wherein the user input specifies a pan, tilt, and/or zoom process that is to be performed on the input image signal.

8. The method of claim 1 further comprising demosaicing the undistorted image signal to obtain a full color image.

9. An imaging system for providing an undistorted view of a selected portion of a lens-distorted optical image, comprising:
a lens for obtaining a lens-distorted input optical image;
a digital image capture unit for capturing the input optical image to obtain an input image pattern having a single color channel per pixel; and
a processor transforming a selected portion of the input image pattern to produce an undistorted output image, wherein the processor is configured to perform the transformation by dewarping the input image pattern in Bayer space using color correlation-adjusted linear interpolation.

10. The imaging system of claim 9 wherein the lens is a wide-angle lens.

11. The imaging system of claim 9 wherein the color correlation-adjusted linear interpolation technique is an edge sensing linear interpolation technique.

12. The imaging system of claim 9 wherein the digital image capture unit includes a Bayer filter and the input image pattern is a Bayer image pattern.

13. The imaging system of claim 9 further comprising a user input for receiving user input selecting the portion of the input image signal to be dewarped.

14. The imaging system of claim 13 wherein the user input specifies a pan, tilt, and/or zoom process that is to be performed on the input image signal.

15. The imaging system of claim 9 further comprising an image signal processor for demosaicing the undistorted output image to obtain a full color image.

16. At least one computer-readable medium encoded with instructions which, when executed by a processor, performs a method including:
receiving a distorted input image signal that is represented in Bayer space; and
dewarping at least a portion the distorted input image signal in Bayer space using color correlation-adjusted linear interpolation.

17. The computer-readable medium of claim 16 further comprising performing the color correlation-adjusted linear interpolation using, for each of a plurality of selected coordinate points in the input image signal, a plurality of pixels neighboring each selected coordinate point which are located within a window of predetermined size.

18. The computer-readable medium of claim 16 wherein the color correlation-adjusted linear interpolation technique is an edge sensing linear interpolation technique.

19. The computer-readable medium of claim 16 further comprising receiving user input selecting the portion of the distorted input image signal that is to be dewarped.

20. The computer-readable medium of claim 17 further comprising selecting the plurality of pixels neighboring each selected coordinate point based at least in part on an inter-color correlation strength arising in different directions within the window.
